(19) United States
(12) Patent Application Publication
(10) Pub. No.: US 2005/0258798 A1
(43) Pub. Date: Nov. 24, 2005

(54) Battery charging device and method for the charging of batteries with several battery blocks

(76) Inventor: Karl Meier-Engel, Walkringen (CH)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/416,141

(22) PCT Filed: Aug. 31, 2001
(86) PCT No.: PCT/CH01/00527

§ 371 Date: May 7, 2003

(30) Foreign Application Priority Data
Nov. 9, 2000 (CH) 2185/00

(51) Int. Cl. H02J 7/00

(52) U.S. Cl. 320/107

(57) ABSTRACT

Battery charging device and method for charging batteries by means of a power supply module, whereby a battery (30) comprises a plurality of battery blocks (31, 32, 33, . . . , 3n) connected in series. The individual battery blocks (31, 32, 33, . . . , 3n) of the battery (30) are charged serially one after the other, once per charging cycle for a definable duration, and the charging cycle is repeated so many times until the individual battery blocks (31, 32, 33, . . . , 3n) have reached a definable state of charge or until the power supply is broken. The invention relates in particular to methods and systems for charging batteries (30) in electric vehicles, among other things.

This invention relates to a battery charging device and method for charging batteries by means of a power supply module, whereby a battery comprises a plurality of battery blocks connected in series. The invention relates in particular to methods and systems for charging batteries in electric vehicles, among other things.

Rechargeable batteries and corresponding devices for recharging such batteries have been known for many years, and are state of the art. Although the batteries and devices for charging batteries available today are still far from satisfying all demands of technology, there are a wide range of applications in many technological fields. Among these fields are not just exotic ones such as space technology and solar energy technology. In practically all mobile devices as well as in other apparatus, which have to function for long periods of time e.g. without human surveillance, rechargeable batteries form the backbone for interim storage of electrical energy. A typical area of application thereby are solar-powered measuring devices or other apparatus for data acquisition, electromobiles, mobile radio devices, etc. etc. Rechargeable batteries, as the name says, must be periodically charged. For loading, the batteries are normally connected to the public power supply network intermittently, via a solar facility by means of solar cells or via a generator operated with a fuel, such as fossil fuels.

A special area of application of rechargeable batteries are so-called electromobiles, i.e. automobiles with electric drive. The enormous success of the automobile in the twentieth century has led to an unbelievable flood of automobiles on the road. This has had the inevitable consequence that the negative aspects of automobiles with combustion engines based on fossil raw materials have developed into difficult-to-solve problems. Among these problems are, in particular, the pollutant exhaust of CO, CO₂, etc., but also the declining supply of the natural resources of such raw materials. It may be said that the exhaust of “greenhouse gases”, such as the mentioned CO₂, is viewed by scientists today as one of the greatest threats to the further existence of humankind on the earth. Climatic catastrophes and lack of equilibrium in the water balance of the seas are only two of the possible horror scenarios. Nevertheless hardly anyone seems willing to give up the mobility achieved in the last century. It must therefore be among the primary goals of scientific research to find ways out of the dilemma and the catastrophe looming ahead. Electromobiles and other vehicles based on electric drive could play an important role in the near future in solving the mentioned problems.

In order to be able to power the electromotors of the electromobiles, they are normally equipped with batteries for interim storage of the electrical energy needed. The performance or efficiency of such electromobiles are greatly determined by the features of the battery and their optimal battery management. Important parameters thereby are, inter alia, costs and weight of the batteries, number of possible cycles of recharging, charging speed, simplicity of handling, disposability, etc. Experiments with different batteries show that lead accumulator storage batteries (lead-acid) generally have a lower energy density and a shorter life cycle than e.g. cadmium-nickel storage batteries or nickel-metal hybrid accumulators, such as iron-nickel storage batteries. Unfortunately the batteries with a high energy density and more life cycles are also significantly more expensive. For appliances with low power consumption, such as mobile radio devices, etc., the cost factor for the battery does not carry that much weight. In the case of devices with high electricity requirements, such as electromobiles, the cost factor for the batteries takes on a completely different dimension. The price of the batteries can therefore play a decisive role in these areas. One of the questions related thereto is whether the life cycles of the batteries can be improved by means of better battery management, in particular charging technology.

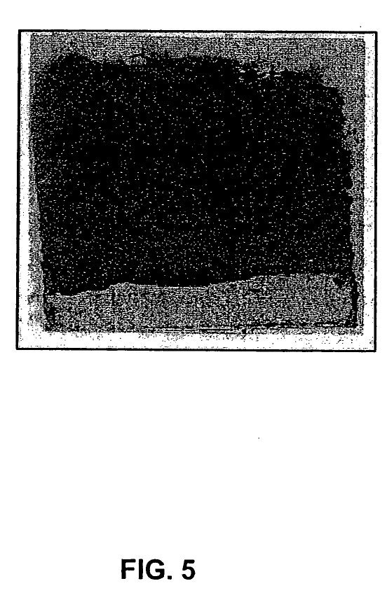

Used, among other things, for devices with high power needs are batteries with individual battery cells connected in series. For such series connections of accumulator batteries, charging devices exist in the state of the art which charge the entire battery string consisting of the various battery blocks via an overall voltage. The voltage of the charging device thereby corresponds to the charging voltage of the battery string. With such charging methods, however, it is difficult to control the individual cell voltages and charging currents. This has the drawback, inter alia, that, when the charging is prematurely terminated, the battery cells have different states of charge. In the use of electromobiles, however, it is frequently even desirable for a user to be able to interrupt the charging of the batteries at any particular moment in the charging process. A further drawback is that in such charging systems the voltages of the individual cells can reach such high values that an increased production of hydrogen and oxygen occurs. Above all with maintenance-free batteries, this leads to a loss of water. The consequence is corrosion of the upper part of the lead grid (cf. FIG. 5). This effect leads to premature failure, i.e. a shortened life of the cell. In addition, with the charging methods of the state of the art it is difficult to determine optimally the so-called end-of-charge condition without ending up thereby with an overcharging of individual battery blocks. Such an over-charge can lead to serious damage in certain types of rechargeable batteries and likewise shorten their life significantly. In the scientific literature (see e.g. Pavlov D., Petkova G., Dimitrov M., Shiomi M. and Tsubota M., “Influence of fast charge on the life cycle of positive lead-acid battery plates, Journal of Power Sources 87 2000, pp. 39-56), it has been known for years that, with certain batteries, the life is improved in cycle operation through use of high charging currents. This could be confirmed with our experiments on the test rig of the HTA Biel-Bienne (Hochschule für Technik und Architektur Biel-Bienne) (University for Technology and Architecture Biel-Bienne) (concerning this see Meier-Engel, Karl, VEBILA, “Verbesserung der Lebensdauer von Batterien mit einem intelligenten Ladegerät;” (Improvement of the life of batteries with an intelligent charging device), Annual Report 2000 HTA Biel-Bienne, Department of Automobile Mechanics). The advantage of using high charging voltages for charging often cannot be availed of because, among other things, the costs of the charging devices climb sharply with increasing power.

It is the object of this invention to propose a new method and system of charging batteries with a plurality of battery blocks which does not have the described drawbacks. In particular, it should be possible to determine precisely the end-of-charge conditions, to use higher charging voltages, to shorten the charging cycles, and to interrupt the charging process at any time without the individual battery cells of the accumulator having greatly differing states of charge. At the same time, the costs for such a battery charging device should be kept within affordable limits by means of the invention.

This object is achieved according to the invention through the elements of the independent claims. Further advantageous embodiments follow moreover from the dependent claims and from the description.

In particular these objects are achieved by the invention in that batteries with a plurality of battery blocks or respectively battery cells are charged by means of a power supply module, the individual battery blocks of a battery being charged serially one after the other, once per charging cycle, for a definable duration, and the charging cycle is repeated so many times until the individual battery blocks have reached a defined state of charge or until the power supply via the power supply module is disconnected. This embodiment variant has the advantage, among other things, that higher charging currents can be used for charging the batteries than in the state of the art. In addition, the end-of-charge conditions can be more precisely determined. Another advantage is that the charging cycle is shortened even with lower charging currents. If the charging of the battery is prematurely interrupted, it can be ensured through the multiple serial charging that the individual battery blocks do not exceed a maximal, predefinable charge difference, i.e. the battery blocks are in close to the same state of charge even with a premature termination of the charging, which results in further advantages. Further advantages are, among other things, that the power supply module only has to be designed for one battery block. Thus the costs of producing the power supply module can be reduced. Since each battery block is individually charged, the voltage and the temperature of the individual battery block can, as mentioned, be monitored and maintained exactly. During the pauses in a charging cycle, the battery blocks can cool off. As a further advantage, the above-mentioned features and advantages result in a higher charging cycle number and a longer life of the batteries.

In an embodiment variant, the switching from one battery block to the next takes place automatically during a charging cycle by means of a changeover switch. The changeover can take place e.g. electronically and/or in an electronically controlled way. This embodiment variant has the advantage, among other things, that the charging can take place without the help of a user.

In a further embodiment variant, the charging of an individual battery block per charging cycle takes place for a duration of 30-300 seconds. This has the advantage, among other things, that with a premature termination of the charging the battery blocks do not have charge differences which are too great. Furthermore, in this time span, the ratio of charging amperage to heating up of the battery can be optimized. Thus a battery block can e.g. cool off sufficiently during charging of the other battery blocks, so that no damage arises in the battery blocks owing to overheating. This overheating of the batteries, or respectively battery blocks, during charging with conventional methods is one of the main problems of the state of the art.

In another embodiment variant, each charging of an individual battery block per charging cycle corresponds to a capacitance of 1/240 to 1/12 of the overall capacitance. This embodiment variant has the same advantages, among other things, as the preceding embodiment variant.

In an embodiment variant, per battery block, the charging current is switched on and off by means of two electronic switches. The electronic switches can comprise e.g. one or more MOS-FET transistors. This embodiment variant has the advantage, inter alia, that with the MOS-FET transistors a cost-efficient design of the electronic switch is involved in which standard state-of-the-art components available on the market can be used.

In a further embodiment variant, a control device with a microprocessor controls the electronic switches and/or functions of the power supply module for charging batteries. As a variant, the control device can, with a microprocessor, measure at least voltage and/or temperature of the battery block which is being charged, and control the charging cycle based on the measured data. Furthermore the control device with the microprocessor can be programmed such that the charging cycle is ended upon reaching a pre-definable charging characteristic. This embodiment variant has the advantage, among other things, that the charging of the batteries can be controlled in a way which is automatic and controllable for the user.

It should be stated here that, besides the method according to the invention, the present invention also relates to a system for carrying out this method. Furthermore it is not limited to rechargeable batteries of electromobiles, but (it relates) in a completely general way to batteries with a plurality of battery blocks connected in series.

Embodiment variants of the present invention will be described in the following with reference to examples. The examples of the embodiments are illustrated by the following attached figures:

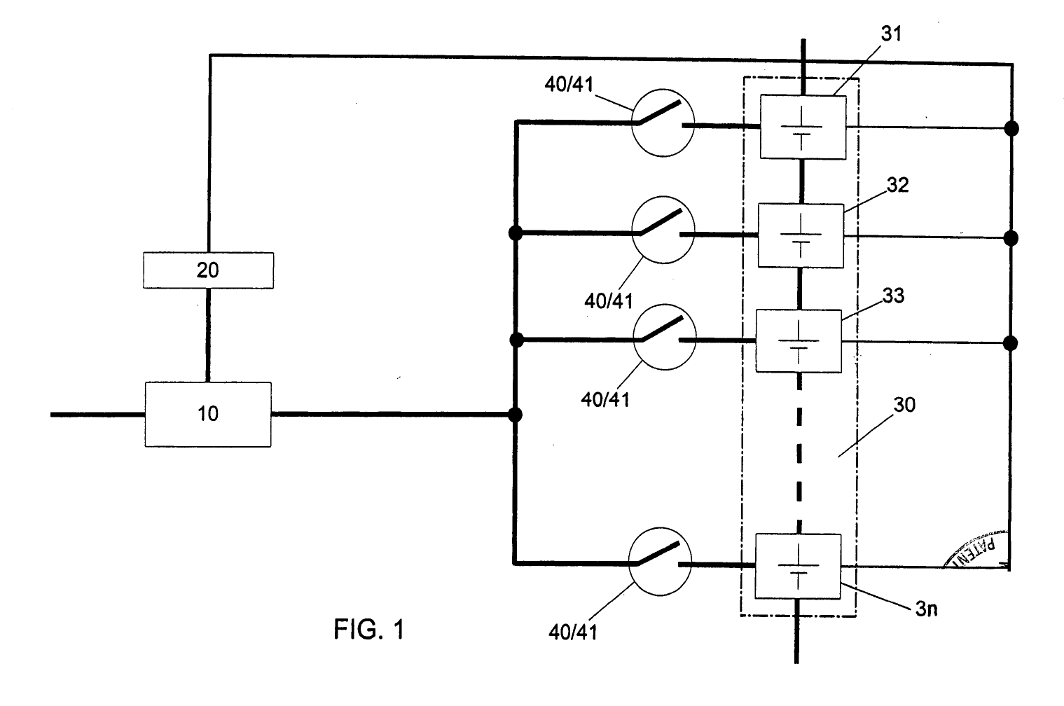

FIG. 1 shows a block diagram showing schematically the architecture of an embodiment variant of a battery charging device according to the invention for charging batteries 30 with a plurality of battery blocks 31, 32, 33, . . . , 3n.

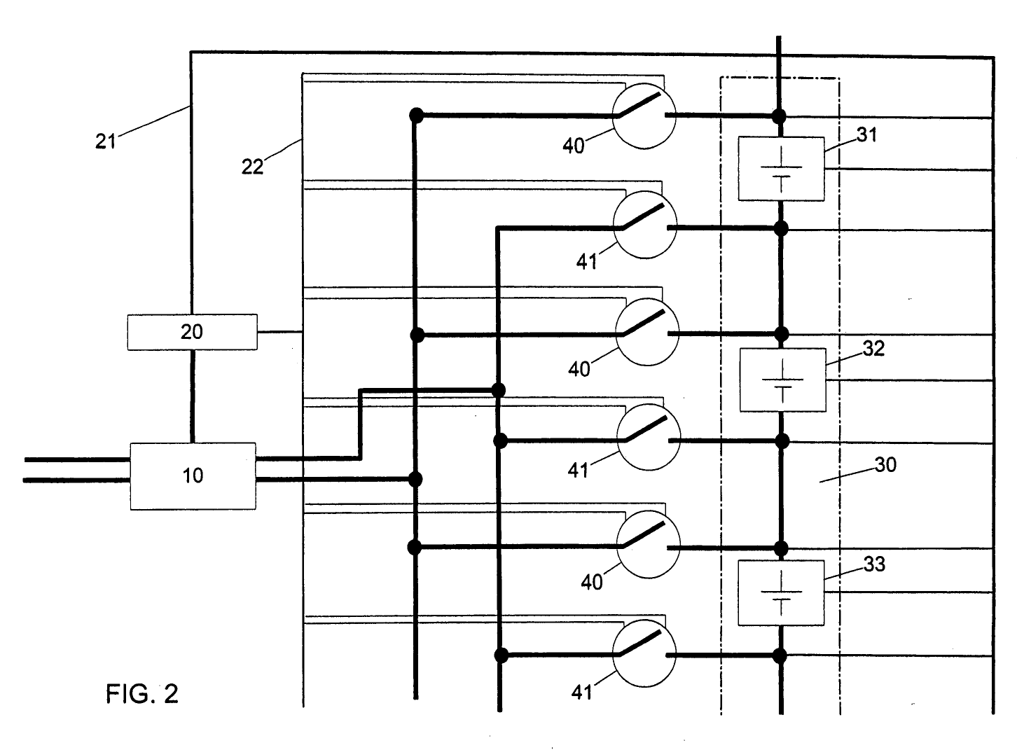

FIG. 2 likewise shows a block diagram showing schematically the architecture of an embodiment variant of a battery charging device according to the invention for charging batteries 30 with a plurality of battery blocks 31, 32, 33,. . . , 3n in more detail than in FIG. 1.

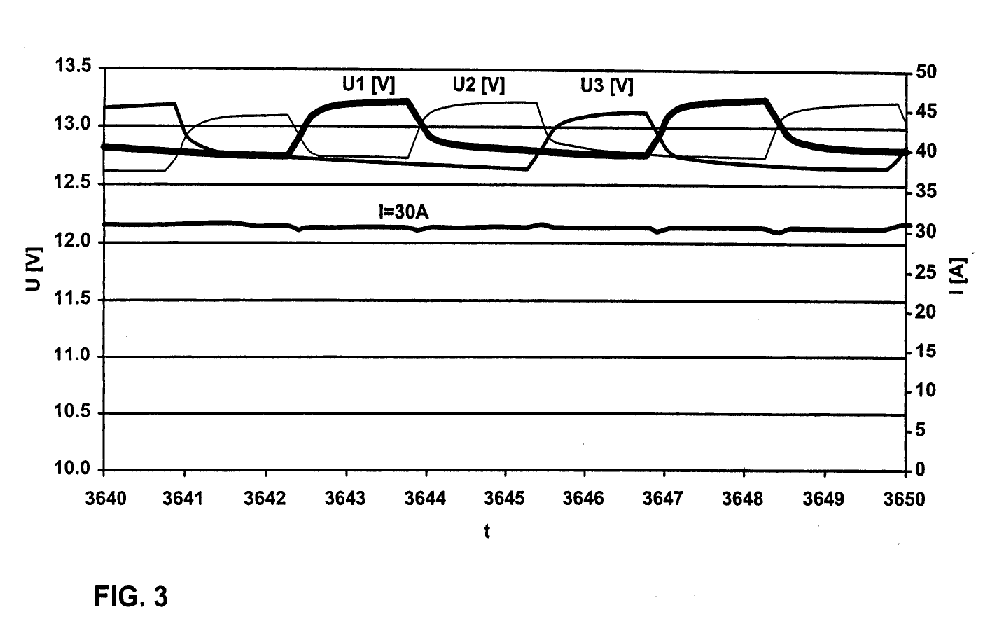

FIG. 3 shows a measurement diagram showing schematically the voltage course of the individual battery blocks during the charging. In the I-phase a constant current is used for charging. During this charging phase, the battery blocks can have different voltages, as in this diagram.

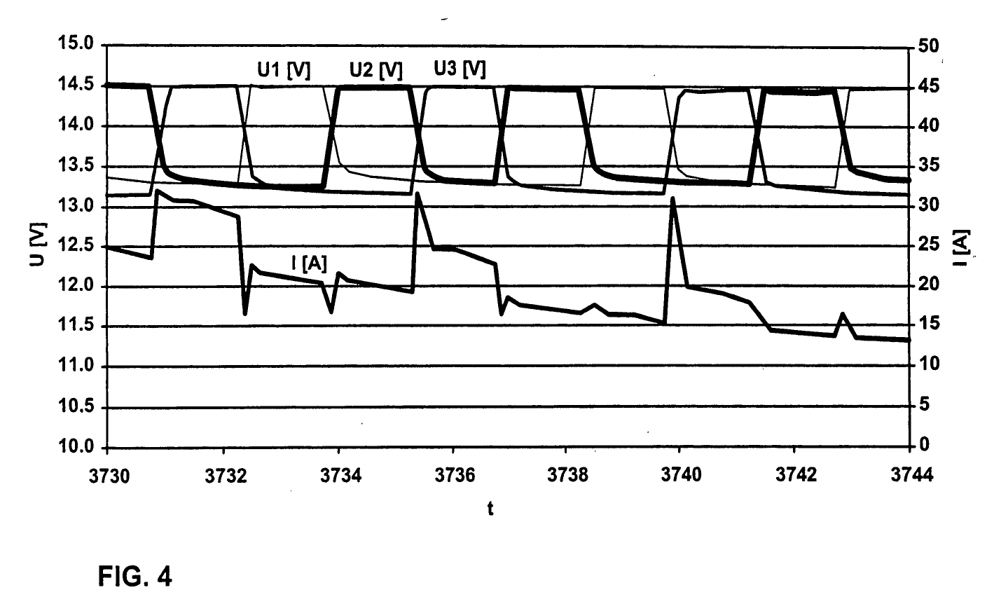

FIG. 4 shows a measurement diagram showing schematically the voltage course of the individual battery blocks during the charging. In the U-phase, the voltage is set to a fixed value. During this charging phase, the battery blocks can have different currents as in this diagram.

FIG. 5 shows the positive electrode of a test battery after a life cycle test. The positive electrode shows strong corrosion of the grid in the upper portion, which was evidently increased by water loss.

FIG. 1 illustrates an architecture which can be used to achieve the invention. In this embodiment example, the battery charging device for charging batteries comprises a power supply module 10, whereby a battery 30 comprises in each case a plurality of battery blocks 31, 32, 33, . . . , 3n connected in series. The batteries 30 can be e.g. lead accumulator storage batteries (lead-add), cadmium-nickel storage batteries, nickel-metal hybrid accumulators, such as iron-nickel storage batteries, batteries of fuel cells, such as e.g. solid oxide fuel cell (SOFC), proton exchange membrane fuel cell (PEM-FC) or direct methanol fuel cell (DMFC), super capacitors (supercaps) and/or ultra-capacitors (ultracaps). For mobile applications, such as, for example, motor vehicles or respectively electromobiles, which use batteries based on fuel cells, fuel cell types with comparatively low operating temperature such as PEM-FC are especially suitable. The battery charging device according to the invention very generally relates, however, to rechargeable batteries consisting of a plurality of battery cells or respectively battery blocks connected to one another. The individual battery blocks 31, 32, 33, . . . , 3n of a battery 30 are charged serially one after the other, once per charging cycle, for a definable duration by means of switches 40/41, and the charging cycles are repeated so many times until the individual battery blocks 31, 32, 33, . . . , 3n have reached a definable state of charge or until the power supply via the power supply module 10 is disconnected. Meant by a definable state of charge is not that the charging cannot be prematurely interrupted. On the contrary, it should thereby be assumed that the state of charge of the battery 30 is simply determined differently in the case of a premature interruption of the charging. In the battery charging device the changeover can take place automatically and/or electronically and/or in an electronically controlled way. The switching on and off of the charging current per battery block or respectively battery cell can be achieved by means of two electronic switches 40/41. The electronic switches 40/41 can comprise e.g. at least one MOS-FET transistor. Such an embodiment variant thereby has the advantage that MOS-FET transistors are relatively cost-effective standard components which are therefore also easily obtainable. Charging current can be supplied to a battery block 31, 32, 33, . . . , 3n per charging cycle e.g. for a duration of 30-300 seconds and/or with a capacitance of 1/240 to 1/12 of the overall capacitance per charging cycle. In an embodiment example described here, the battery 30 comprises e.g. battery cells 31, 32, 33, . . . , 3n each with 12 V. The charging current amounted, for example, to 0.5 C or more, and the charging time was, as described, 30-300 seconds. The charging current can be supplied via the power supply module 10, which is connected e.g. to the public power supply network and/or solar cells and/or a fossil-fuel-based power generator, etc. Depending upon current supply, the power supply module 10 can comprise an AC/DC converter. The charging process is continued e.g. until the connection to the public power supply network is disconnected or the batteries are completely charged. The electronic and/or electronically controlled changeover can take place by means of a control device 20, whereby the control device 20 can comprise one or more microprocessors and/or storage modules. The control device 20 controls and monitors the electronic switches 40/41 and/or the functions of the power supply module 10. Thus, for example, the charging cycle can be interrupted by means of the control device 20 when a definable charging characteristic has been achieved. In an embodiment variant, the control device monitors in particular the charging parameters, e.g. periodically, such as, for example, voltage and temperature of the individual battery blocks and/or batteries. The voltage regulation can take place preferably in dependence upon the battery temperature. For electrical connections between power supply module 10, control device 20 and switches 40/41, e.g. ribbon cable and/or single cable can be used. For transmission of measurement signals, a data bus can connect the control device 20 to the corresponding measurement devices.

FIG. 2 illustrates an architecture which can be used to achieve the invention. This embodiment example comprises the same features as the embodiment example according to FIG. 1. The description of FIG. 1, including the reference numerals, applies in an identical way also to FIG. 2, FIG. 2 showing a more detailed representation of an embodiment example. In particular, the electrical connections between the power supply module 10, the control device 20 and switches 40/41 are specifically shown, without however the general nature of the battery charging device or of the method for charging batteries being thereby limited in any way. As described, the electrical connections can be achieved e.g. with ribbon cable and/or single cable. For transmission of measurement signals and/or the control signals, a data bus can connect the control device 20 to the respective measuring devices or respectively switches 40/41. In FIG. 2, the reference numeral 21 indicates the measurement lines, i.e. the connection of the control unit 20 to the measuring devices, whereby the signals for measuring the voltage and/or the temperature and/or further state of charge parameters can be transmitted to the control unit 20. The state of charge parameters are measured directly at the individual battery blocks 31, 32, 33, . . . , 3n of the battery 30 to be charged. Reference numeral 22 represents the control lines, i.e. the connections for transmission of the control commands for switching of the switches 40/41. In FIG. 2 the switches 40/41 are now shown separately, the reference numerals 40 being, for instance, electronic switches, such as e.g. MOS-FET transistors, for interruption of the positive connection, whereas the reference numerals 41 are, for example, electronic switches, such as e.g. MOS-FET transistors, for interruption of the negative connection. The power supply module 10, as shown in FIGS. 1 and 2, can be produced with commonly available components, e.g. of the company VICOR (cf. VICOR Product User Guide (2000), http://www.vicr.com). One possible realization would be achieved e.g. with a VI-ARM-C12 input module (in: 90 to 264 VAC at 750 W max. temperature range: −25° C. to 85° C.) together with a VI-261-CU-BM DC-DC converter (in: 300 VDC, out: 12 VDC at 200 W, temperature range: −25° C. to 85° C.) and a VI-B61-CU-BM booster module (in: 300 VDC, out: 12 VDC at 150 W, temperature range: −25° C. to 85° C.). It is to be pointed out, however, that such power supply modules 10 belong to the state of the art, just as the manufacture of the power supply module 10 is known to one skilled in the art in this field both in this design as well as in any other design. These mentioned VICOR components could be configured, for example, in a cooling body and with a housing secured against contact with persons. With suitable construction, the power supply module 10 should also get by without cooling, e.g. through a cooling ventilator. The output voltage of the power supply module 10 can e.g. be monitored by the electronic control device 20 and can be regulated via the input voltage Vᵢₙ. The charging current can be controlled via the input current Iᵢₙ. In this embodiment example, the control device 20 comprises four modules: a module for measuring the temperature and the voltage of the individual battery blocks, optionally with a 230 V detection (described further below), a microprocessor, an output module and a driver module. The modules can be accommodated e.g. in a metal housing, the connection taking place with ribbon cable. In another embodiment example, the connection can also take place e.g. via a bus system. The temperature measurements at the battery blocks 31, 32, 33, . . . , 3n can be taken, for instance, by means of temperature sensors. A possibility therefor from the state of the art would be the use of a temperature sensor KTY-10 of the Siemens company. In this embodiment example, this would be fed directly with the voltage source of the microprocessor, which has the advantage that the measurement value can be supplied directly to the microprocessor. By means of a potentiometer, the temperature can be correspondingly calibrated. In the same way it is possible to measure the temperature at further battery blocks 31, 32, 33, . . . , 3n. The voltage measurement of the individual battery blocks 31, 32, 33, . . . , 3n can be carried out with printed circuit board relays. These are switched on by the microprocessor as soon as the respective battery block 31, 32, 33, . . . , 3n is charged. The supply of the printed circuit board relays can take place e.g. with 12 V. If the battery 30 is used in an electromobile, the board voltage of the electromobile can be used. The activation of one or more microprocessors can take place via optical couplers and/or transistors, an electric locking preventing two printed circuit board relays from being switched at the same time. In the embodiment example, the measurement values are supplied to the at least one microprocessor via a buffer amplifier. Before the buffer amplifier the voltage of the battery block is reduced to a factor of 0.294 of the voltage. Thus at the microprocessor a voltage of 5 V corresponds to a voltage of 17 V at the battery blocks 31, 32, 33, . . . , 3n. The voltage can be calibrated e.g. by means of potentiometer. In this embodiment example, a DC/DC converter supplies the buffer amplifier input with voltage. The output of the buffer amplifier is supplied with voltage from the DC/DC converter of the microprocessor. The mentioned 230 V detection can be used to determine whether the battery charging device, which is located e.g. in an electromobile, is connected to a power supply such as the public power supply network or not. With an optical coupler HP HCPL3700, the alternating current can be rectified, and digital signals can be generated for the microprocessor.

The microprocessor is usually installed on a mother board or a printed circuit board. Supply can take place via a DC/DC converter and a 5 V regulator. For programming the computer, one of the common programming languages can be used. During electronic control of the changeover from one battery block to the next, the switching is controlled by the microprocessor. The charging time of a battery block in this embodiment example is preferably 30-300 seconds. However, other times are also conceivable in principle. Optimized preferably during this process should be the relationship of the magnitude of the charging current and the heating of the battery block together with the cooling off phases during the charging of the other battery blocks. The described voltage Vᵢₙ of the power supply module 10 can be generated via an analog output. The charging terminal voltage can be calibrated e.g. via a potentiometer. The control of the output current has been achieved in this embodiment example by means of two digital outputs. Two different currents can thereby be controlled, for example during the I-phase. In the present embodiment example, a distinction has been made between I-phase and U-phase for the charging process. During the I-phase, each battery block is charged with a constant current, e.g. 30 A, amounting to at least 0.5 C, however. During this phase, the battery blocks can have different voltages, as shown in FIG. 3 for the charging of a battery with 3 battery blocks. The time axis t in FIG. 3 indicates the time in minute units. During the U-phase, on the other hand, charging is with a constant voltage. Now the battery blocks can thereby have different currents. The U-phase is shown in FIG. 4, likewise for a battery with three battery blocks. Again the time axis t in FIG. 4 indicates the time in minute units. In the diagram shown, for example, the charging current of the third battery block is clearly higher than that of the battery blocks 1 and 2.

By means of this architecture, the embodiment example described here has the advantage that higher charging currents can be used for charging the battery than in the state of the art. The end-of-charge conditions can also be thereby determined more precisely. Another advantage is that the charging cycle is shortened, even with lower charging currents. Should the charging of the battery be prematurely interrupted, it can be ensured through the multiple serial charging that the individual battery blocks do not exceed a maximal, predefinable charge difference, i.e. the battery blocks are in close to the same state of charge even with a premature termination of the charging. The embodiment example also has the advantage that the power supply module only has to be designed for one battery block. The costs of producing the power supply module can thus be reduced. Since each battery block is individually charged, the voltage and the temperature of the individual battery block can be monitored and maintained exactly. During the pauses in a charging cycle, the battery blocks can cool off. As a further advantage, the above-mentioned features and advantages result in a larger number of charging cycles and a longer life for the batteries. The drawbacks of the state of the art, such as overheating of the batteries and lower charging currents, can thus be avoided. FIG. 5 shows the picture of a positive electrode, damaged through the charging cycles, of a test battery (HAWKER GENESIS 37 Ah) after charging with a conventional charging method, the charging current having been applied over the entire battery. The positive electrode of the test battery displays strong corrosion in the upper portion of the grid. The microfiberglass separator of this maintenance-free battery is relatively dry, from which it can be concluded that the above-mentioned drawbacks of the state of the art have led to too high a water loss, which accelerated the corrosion of the battery.

In the present embodiment example, the output signals of the microprocessor are relayed to the driver module with a potential separation. For electromobiles, for example, the control of the vehicle drive can be switched off as soon as the battery charging device operates by closing a relay provided therefor. In this way it can be ensured that the driver does not drive away with the vehicle while the electromobile is still connected to the public power supply network by means of the charging plug. For indication of the end of the charging process, e.g. an NPN small signal transistor can be used, for example. This becomes conductive as soon as the charging is terminated, and thus generates an external signal. Depending upon embodiment example, it can make sense for different operational conditions of the battery charging device to be displayed. Examples of such battery states are: battery charging device is in operation, alarm temperature (battery or respectively battery block is too hot), charging cycle or charging process is completed. The maximal value of the charging current can be adjusted e.g. by means of a relay via Iᵢₙ. In addition, a second charging current can also be controlled by means of a potentiometer, if such a second charging current is necessary in an embodiment. Thus, if need be, a second I-phase can be generated. The printed circuit board relays for switching on the battery block can be integrated e.g. into the driver module. One relay each can thereby be used for each battery block for control of the changeover 40 at the positive pole and one relay for control of the changeover 41 at the negative pole. The control voltage necessary therefor for the positive and the negative pole can be generated e.g. through a DC/DC converter.

Used for the electronic switches 40/41 in this embodiment example are FET-MOS-FET <sic. MOS-FET> transistors. This has the advantage, among other things, that with the MOS-FET transistors a cost-efficient design of the electronic switches is involved in which standard state-of-the-art components available on the market are used. Other designs for the switches 40/41 are conceivable, however. Thus, for example, instead of the MOS-FET transistors, any other semiconductor or a relay can be used in order to achieve the switching of the charging current. Since MOS-FET transistors have an inverse diode, their effect must be broken with a diode since otherwise the potential separation of the individual battery blocks could not be ensured. Temp-FET transistors were used for the embodiment example which are automatically switched off in the case of excess temperature. Thus an overheating of the transistor cannot cause any failure of the transistor. Transmission of the control signals can take place e.g. via cable or a data bus.

It is important to point out that the number of battery blocks, or respectively battery cells, per battery is not limited by the device according to the invention for charging such batteries. Thus it is conceivable that in the case of a large number of battery blocks a plurality of charging devices are used in parallel. The method according to the invention and the device according to the invention is thereby expandable, scalable and individually adaptable to the given needs, as desired. This advantage as such cannot be found in the state of the art. It should likewise be stated here that, despite the detailed description of the embodiment example, the subject matter of the invention disclosed by the description and the claims is not to be viewed as limited in any way by the technical details indicated. On the contrary, the subject matter according to the invention relates in a completely general way to battery charging devices and methods for charging batteries comprising one or more battery blocks or battery cells connected to one another.

1. A method for charging batteries by means of a power supply module (10), whereby a battery (30) comprises a plurality of battery blocks (31, 32, 33, . . . , 3n) connected in series, wherein
the individual battery blocks (31, 32, 33, . . . , 3n) of a battery (30) are charged serially one after the other, once per charging cycle, during a definable duration, and
the charging cycle is repeated so many times until the individual battery blocks (31, 32, 33, . . . , 3n) have reached a definable state of charge or until the power supply via the power supply module (10) is disconnected.

2. The method for charging batteries according to claim 1, wherein during a charging cycle the switching over of the charging from one battery block (31, 32, 33, . . . , 3n) to the next takes place automatically.

3. The method for charging batteries according to claim 2, wherein during a charging cycle the switching over of the charging from one battery block (31, 32, 33, . . . , 3n) to the next takes place electronically.

4. The method for charging batteries according to one of the claims 1 to 3, wherein the charging of an individual battery block (31, 32, 33, . . . , 3n) per charging cycle takes place for a period of 30-300 seconds.

5. The method for charging batteries according to one of the claims 1 to 4, wherein each charging of an individual battery block (31, 32, 33, . . . , 3n) per charging cycle corresponds to a capacitance of 1/240 to 1/12 of the overall capacitance.

6. The method for charging batteries according to one of the claims 1 to 5, wherein, per battery block (31, 32, 33, . . . , 3n), the charging current is switched on and off by means of two electronic switches (40/41).

7. The method for charging batteries according to claim 6, wherein the electronic switches (40/41) comprise at least one MOS-FET transistor.

8. The method for charging batteries according to one of the claims 6 or 7, wherein a control device (20) with a microprocessor controls the electronic switches (40/41) and/or functions of the power supply module (10).

9. The method for charging batteries according to one of the claims 1 to 8, wherein a control device (20) with a microprocessor measures at least voltage and/or temperature of the battery block (31, 32, 33, . . . , 3n) which is being charged, and controls the charging cycle based on the measured data.

10. The method for charging batteries according to one of the claims 1 to 9, wherein the control device (20) with the microprocessor is programmed such that the charging cycle is ended upon attaining a pre-definable charging characteristic.

11. A battery charging device for charging batteries which comprise a plurality of battery blocks (31, 32, 33, . . . , 3n) connected in series, the battery charging device comprising a power supply module (10), wherein
the battery charging device comprises a changeover switch, by means of which the individual battery blocks (31, 32, 33, . . . , 3n) of a battery (30) are chargeable and/or rechargeable serially one after the other, once per charging cycle, during a pre-determinable period of time, and
the battery charging device comprises a control device (20) by means of which so many charging cycles are programmable until the individual battery blocks (31, 32, 33, . . . , 3n) have reached a definable state of charge.

12. The battery charging device according to claim 11, wherein the battery charging device comprises an automatic changeover switch by means of which the individual battery blocks (31, 32, 33, . . . , 3n) of the battery (30) are chargeable and/or rechargeable serially one after the other, once per charging cycle, during a pre-determinable period of time.

13. The battery charging device according to claim 11, wherein the battery charging device comprises an electronic changeover switch by means of which the individual battery blocks (31, 32, 33, . . . , 3n) of the battery (30) are chargeable and/or rechargeable serially one after the other, once per charging cycle, during a pre-determinable period of time.

14. The battery charging device according to one of the claims 11 to 13, wherein the charging of an individual battery block (31, 32, 33, . . . , 3n) per charging cycle comprises a charging duration of 30-300 seconds.

15. The battery charging device according to one of the claims 11 to 14, wherein each charging of an individual battery block (31, 32, 33, . . . , 3n) per charging cycle corresponds to a capacitance of 1/240 to 1/12 of the overall capacitance.

16. The battery charging device according to one of the claims 11 to 15, wherein per battery block, the charging current is switchable on and off by means of two electronic switches (40/41).

17. The battery charging device according to claim 16, wherein the electronic switches (40/41) comprise at least one MOS-FET transistor.

18. The battery charging device according to one of the claims 16 or 17, wherein the control device (20) of the battery charging device comprises a microprocessor which controls the electronic switches (40/41) and/or functions of the power supply module (10).

19. The battery charging device according to one of the claims 11 to 18, wherein the control device (20) of the battery charging device comprises a microprocessor which measures at least voltage and/or temperature of the battery block (31, 32, 33, . . . , 3n) which is being charged, and controls the charging cycle based on the measured data.

20. The battery charging device according to one of the claims 11 to 19, wherein the control device (20) with the microprocessor is programmable such that the charging cycle is ended upon attaining a pre-definable charging characteristic.
